(19) United States
(12) Patent Application Publication
(10) Pub. No.: US 2009/0188386 A1
(43) Pub. Date: Jul. 30, 2009

(54) Method and Device for Controlling Relative Humidity in an Enclosure

(75) Inventors: Paul Allison Beatty, Fort Collins, CO (US); James Hart Smith, Woodside, CA (US)

Correspondence Address: CAMPBELL NELSON WHIPPS, LLC, HISTORIC HAMM BUILDING, 408 SAINT PETER STREET, SUITE 240, ST. PAUL, MN, 55102, US

(73) Assignee: SEAGATE TECHNOLOGY LLC, Scotts Valley, CA (US)

(21) Appl. No.: 12/416,975

(22) Filed: Apr. 2, 2009

Related U.S. Application Data
(63) Continuation-in-part of application No. 12/355,520, filed on Jan. 16, 2009.
Application No. 12/355,520 is a continuation of application No. 10/970,960, filed on Oct. 22, 2004, now Pat. No. 7,478,760.
Application No. 10/970,960 is a continuation-in-part of application No. 11/709,182, filed on Feb. 21, 2007.
(60) Provisional application No. 60/548,028, filed on Feb. 26, 2004.

(51) Int. Cl. B01D 53/26; B01D 53/02; B01J 20/04

(52) U.S. Cl. 95/91; 96/118; 252/194

(57) ABSTRACT

Methods of controlling relative humidity in an enclosure that include preparing an aqueous solution, the aqueous solution including a hydratable salt, the hydratable salt including a divalent cation; preparing a second composition, the second composition including the aqueous solution; and polyacrylamide, a copolymer of polyacrylic acid and polyacrylamide, or both; and placing the second composition in the enclosure, wherein the second composition absorbs water from the atmosphere of the enclosure. Devices and systems including desiccants are also disclosed.

### PRIORITY

This application is a continuation-in-part of U.S. patent application Ser. No. 12/355,520, entitled “HUMIDITY CONTROL METHOD AND APPARATUS FOR USE IN AN ENCLOSED ASSEMBLY”, filed on Jan. 16, 2009, which is a continuation of U.S. patent application Ser. No. 10/970,960, filed Oct. 22, 2004, which issued on Jan. 20, 2009 as U.S. Pat. No. 7,478,760 and was based on and claims the benefit of U.S. Provisional Application No. 60/548,028 filed on Feb. 26, 2004; and is a continuation-in-part of U.S. patent application Ser. No. 11/709,182, entitled “DESICCANT”, filed on Feb. 21, 2007, which published as United States Patent Publication No. 2008/0196591, the disclosures of which are incorporated herein by reference.

### BACKGROUND

Numerous devices can benefit from controlling the relative humidity within them or within the area that they function. Exemplary types of articles that can benefit from relative humidity (RH) control include electronic articles. Control of relative humidity can be beneficial within an electronic article because the amount of moisture within an electronic device may affect the performance and reliability of the electronic device. A specific example of an electronic device that can benefit is a memory device, such as a disc drive for example. Control of the moisture within a disc drive can affect the performance and reliability of the head/disc interface by mediating RH-driven damage mechanisms such as head-to-disc stiction. Further, high moisture may increase corrosion of the memory media and low moisture levels have been observed to contribute to excessive disc wear. Therefore, there always remains a need for novel and advanced methods of controlling relative humidity.

### BRIEF SUMMARY

Disclosed is a method of controlling relative humidity in an enclosure that includes preparing an aqueous solution of a hydratable salt, the hydratable salt including a divalent cation; preparing a second composition, the second composition including: the aqueous solution; and polyacrylamide, a copolymer of polyacrylic acid and polyacrylamide, or both; and placing the second composition in an enclosure, wherein the second composition absorbs water from the atmosphere of the enclosure.

Disclosed is a desiccant that includes polyacrylamide, a copolymer of polyacrylic acid and polyacrylamide, or both; a hydratable salt that includes a divalent cation; and at least one divalent cation.

Disclosed is a humidity control system that includes an enclosure; a desiccant, the desiccant including polyacrylamide, a copolymer of polyacrylic acid and polyacrylamide, or both; a hydratable salt, the hydratable salt including a divalent cation; and at least one divalent cation, wherein the desiccant controls the relative humidity within the enclosure.

These and various other features and advantages will be apparent from a reading of the following detailed description.

### BRIEF DESCRIPTION OF THE DRAWINGS

The disclosure may be more completely understood in consideration of the following detailed description of various embodiments of the disclosure in connection with the accompanying drawings, in which:

FIG. 1 is a graph showing the relative humidity (RH) above different saturated solution as a function of temperature;

FIG. 2 is a graph of RH % versus time of a solution of magnesium chloride (MgCl₂) in a 3.5 inch desktop disc drive;

FIG. 3 is a partial cross-sectional view of an embodiment of a desiccant disclosed herein;

FIG. 4 is a partial cross-sectional view of an embodiment of a humidity control system disclosed herein;

FIG. 5 is an oblique view of a disc drive that includes a desiccant as disclosed herein;

FIG. 6A is a diagrammatic view of another embodiment of a desiccant as disclosed herein;

FIG. 6B is a cross-sectional view of another embodiment of a desiccant as disclosed herein;

FIG. 7 is a diagrammatic view of another embodiment of a desiccant as disclosed herein;

FIG. 8 is a graph obtained in Example 1;

FIG. 9 is a graph obtained in Example 2;

FIG. 10 is a graph obtained in Example 3;

FIG. 11 is a graph obtained in Example 4.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Embodiments other than those specifically discussed herein are contemplated and may be made without departing from the scope or spirit of the present disclosure. The following detailed description is not limiting. The definitions provided are to facilitate understanding of certain terms frequently used and do not limit the disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g., 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification, use of a singular form of a term, can encompass embodiments including more than one of such term, unless the content clearly dictates otherwise. For example, the phrase “adding a solvent” encompasses adding one solvent, or more than one solvent, unless the content clearly dictates otherwise. As used in this specification and the appended claims, the term “or” is generally employed in its sense including “either or both” unless the context clearly dictates otherwise.

“Include,” “including,” or like terms means encompassing but not limited to, that is, including and not exclusive.

Disclosed are methods of controlling relative humidity in an enclosure; desiccants; and humidity control systems.

Embodiments disclosed herein include methods of controlling relative humidity in an enclosure that include the steps of preparing a first composition, preparing a second composition and placing the second composition in an enclosure, wherein the second composition absorbs water from the atmosphere of the enclosure.

The first composition generally includes a hydratable salt and water. The first composition is generally an aqueous solution. The amount of a non-volatile component (solute) that will dissolve in water is often limited. The maximum amount that can dissolve (the solubility limit) depends at least in part, on the temperature of the solution and the chemical identity of the solute. As more and more solute is added to a given volume of water, a point will be reached when further solute will not dissolve and some pure solute will be present as a distinct solid phase. This condition is known as saturation, and a solution that has met this condition is referred to as a saturated aqueous solution.

In embodiments, the solute in an aqueous solution can be a salt. In embodiments, the solute in a saturated aqueous solution can be a hydratable salt. A hydratable salt is either a salt that has waters of hydration (is a hydrate) or a salt that is capable of having waters of hydration. A water of hydration is water that occurs in a solid salt but is not covalently bonded to the salt. An aqueous solution can be formed using a salt that currently has waters of hydration (a hydrate) or a salt that does not currently have waters of hydration (a dehydrated hydrate). In embodiments, an aqueous solution can be formed with salts that have waters of hydration.

Salts that can be used to form a saturated aqueous solution generally include at least one kind of cation and at least one kind of anion. In embodiments, salts that can be utilized can include cations that have a +2 charge, also referred to herein as divalent cations. In embodiments, salts that can be utilized can include cations that have a charge other than a +2, including, a +1 charge (referred to herein as monovalent cations) or a +3 charge (referred to herein as trivalent cations) for example. Exemplary divalent cations that can be utilized in salts include magnesium (Mg⁺²), calcium (Ca⁺²), strontium (Sr⁺²), barium (Ba⁺²), titanium (Ti⁺²), chromium (Cr⁺²), manganese (Mn⁺²), iron (Fe⁺²), cobalt (Co⁺²), nickel (Ni⁺²), copper (Cu⁺²), zinc (Zn⁺²) and cadmium (Cd⁺²) for example.

In embodiments, salts that can be utilized can include anions that have a −1 charge, also referred to herein as monovalent anions. In embodiments, salts that can be utilized can include anions that have a charge other than a −1, including a −2 charge (referred to herein as divalent anions) or a −3 charge (referred to herein as trivalent anions) for example. Exemplary univalent anions that can be utilized in salts include chloride (Cl⁻¹), bromide (Br⁻¹), iodide (I⁻¹), nitrate (NO₃⁻¹) and nitrite (NO₂⁻¹) for example.

In choosing the salt that is utilized, it is generally desired that it not have any deleterious effects on the instrument, housing or other components within the area whose humidity is being controlled. For example, if the instrument contains polycarbonate components such as a polycarbonate housing that houses the desiccant, a high concentration of a carbonate salt may not be suitable since the saturated solution of the carbonate salt may promote degradation of the housing. Carbonate salts, such as K₂CO₃ will dissociate in water. Specifically K₂CO₃ dissociates in water as follows: K₂CO₃ [symbol] 0 2K⁺+CO₃⁻². The carbonate anion then exists in equilibrium with water as follows: CO₃⁻²+H₂O [symbol] HCO₃⁻+OH⁻. High levels of OH⁻ can raise the pH of the composition to about 11 to 13. For example, a concentrated solution of K₂CO₃ has a pH of about 11. Basic solutions can hydrolyze a polycarbonate desiccant housing of a disc drive and therefore high K₂CO₃ concentrations should be avoided if the desiccant will come into contact with polycarbonate. Ester linkages in polymers such as polyesters and polycarbonate may be subject to hydrolysis under adverse pH conditions. Salts of monovalent strong acids, such as salts that include Cl⁻ (HCl being a strong acid) do not form OH⁻ because they completely dissociate. Therefore, in embodiments salts of strong acids that include anions such as chloride (Cl⁻¹) and bromide (Br⁻¹) can be utilized.

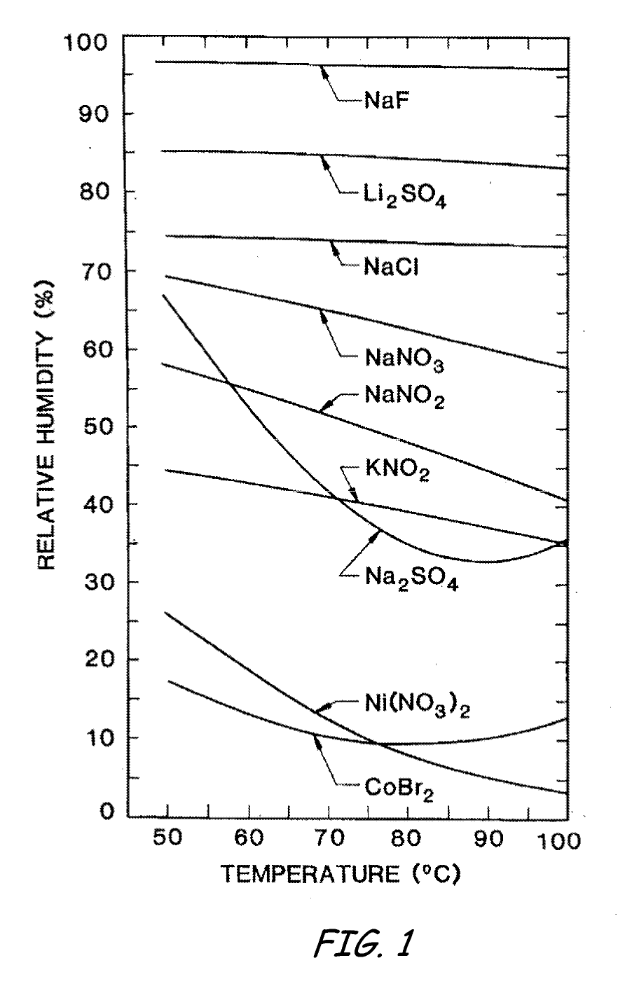

The choice of salt can also depend at least in part on the desired relative humidity level to be maintained. A saturated aqueous solution of a salt has an associated characteristic relative humidity at a given temperature. FIG. 1 is a graph depicting the relative humidity (RH) (%) above saturated solutions of various salts at temperatures from about 50° C. to about 100° C. As seen from FIG. 1, the RH % above saturated solutions of salts can be very different and in some cases can decrease as temperature increases. Given the desired RH in the application, an appropriate salt can be chosen. In embodiments, salts that maintain a relative humidity above about 60% can be utilized. In embodiments, salts that maintain a relative humidity below about 60% can be utilized. In embodiments, salts that maintain a relative humidity between about 10% and 60% can be utilized.

Exemplary salts include barium chloride (BaCl₂) that can have two waters of hydration, barium bromide (BaBr₂) that can have two waters of hydration, barium iodide (BaI₂) that can have two or seven waters of hydration, cadmium chloride (CdCl₂) that can have 5/2 waters of hydration, cadmium bromide (CdBr₂) that can have four waters of hydration, cadmium chloride (CdCl₂) that can have six waters of hydration, calcium chloride (CaCl₂) that can have six waters of hydration, calcium bromide (CaBr₂) that can have six waters of hydration, calcium iodide (CaI₂) that can have eight waters of hydration, magnesium chloride (MgCl₂) that can have six waters of hydration, magnesium bromide (MgBr₂) that can have six waters of hydration, magnesium iodide (MgI₂) that can have eight waters of hydration, strontium bromide (SrBr₂) that can have six waters of hydration, strontium chloride (SrCl₂) that can have two waters of hydration and strontium iodide (SrI₂) that can have six waters of hydration, for example.

The aqueous solution generally includes water, dissolved salt and can include solid salt. The amount of dissolved salt and solid salt in a saturated aqueous solution can depend at least in part on the temperature of the saturated aqueous solution and the chemical identity of the salt. The aqueous solution can be prepared using known methods. Exemplary steps for preparing an aqueous solution of a salt can include adding the salt to water, stirring the solution until the salt dissolves and repeating the addition of the salt and stirring a desired concentration has been reached.

The amount of salt dissolved in water and the amount of solid salt in the water (if any) can depend at least in part on the identity of the salt and the temperature of the aqueous solution. Generally, as the temperature of an aqueous solution is increased, the aqueous solution can dissolve more salt. The solubility limit of magnesium chloride (MgCl₂) for example is about 54.25 grams (g) of dehydrated magnesium chloride per 100 milliliter (mL) of aqueous solution at 20° C. The solubility limit of magnesium bromide (MgBr₂) for example is about 101.50 g of magnesium bromide per 100 mL of saturated aqueous solution at 20° C. It should be noted that solutions containing more salt than will dissolve (e.g. a saturated aqueous solution) can also be utilized in preparing the disclosed second compositions. The amount of salt in the aqueous solution can be characterized in a variety of ways. The amount (mass) of salt, whether anhydrous or hydrated that was added to a given volume of water can be noted as the concentration, or the amount (mass) of hydrated salt added to a given volume of water can be used to calculate the anhydrous amount (mass) of salt in the volume of water for example.

Disclosed methods also include the step of preparing a second composition. The second composition includes the aqueous solution and a polymer. The second composition can also be referred to as a desiccant. Preparing the second composition can be accomplished by adding the polymer to the aqueous solution, by adding a composition including the polymer to the aqueous solution, by adding the aqueous solution to a composition containing the polymer, by adding the aqueous solution to the polymer, or by a combination thereof.

Polymers utilized in the second composition are generally absorbent polymers. An absorbent polymer is a polymer than can absorb and retain extremely large amounts of a liquid relative to the mass of the polymer. The polymer can be crosslinked, not crosslinked, or partially crosslinked. Exemplary absorbent polymers include polyacrylic acid, polyacrylamide copolymer, ethylene maleic anhydride copolymers, cross-linked carboxy-methyl-cellulose, polyvinyl alcohol copolymers, cross-linked polyethylene oxide, starch grafted copolymers of acrylonitrile and polyurethane polyether copolymers. In embodiments, polyacrylamide or copolymers of polyacrylic acid and polyacrylamide can be utilized. An exemplary polyacrylamide polymer is commercially available from JRM Chemical, Inc., Cleveland, Ohio under the trade name SOIL MOIST™ crosslinked polyacrylamide.

In embodiments, absorbent polymers that have acidic functional groups, whether prior to or during formation of the polymer or after the polymer is formed, that react with a base to form a salt can be utilized. One example of a suitable polymer that can be utilized includes polyacrylic acid (PAA) or a mixed polyacrylic acid/polyacrylamide copolymer. A base can be used to produce the salt of PAA. The PAA can be synthesized by first partially neutralizing acrylic acid with a base such as LiOH, NaOH, or KOH. The mixture can then be polymerized to form the PAA salt. Exemplary absorbent polymers than can be utilized can be commercially obtained from Emerging Technologies, Inc. Greensboro, N.C. under the trade name of LIQUIBLOCK™ 40F, which is the potassium salt of crosslinked polyacrylic acid/polyacrylamide copolymer, or under the trade name of LIQUIBLOCK™ 44-0C, which is the sodium salt of crosslinked polyacrylic acid.

Disclosed methods also include the step of placing the second composition within an enclosure. When in an enclosure that includes water vapor, the second composition will absorb water from the atmosphere of the enclosure.

The amount of the aqueous solution and the polymer within the second composition can vary. In embodiments, the amounts of the aqueous solution and polymer can be considered using the volume of the aqueous solution and mass of the polymer. In embodiments, second compositions can include ratios of about 5 g polymer to 1 mL aqueous solution to 1 g polymer to 5 mL aqueous solution. In embodiments, second compositions can include ratios of about 1 gm polymer to 1 mL aqueous solution to 1 gm polymer to 5 mL aqueous solution. In embodiments, second compositions can include ratios of about 1 gm polymer to 1 mL aqueous solution to 1 gm polymer to 2.5 mL aqueous solution. In embodiments, amounts of the aqueous solution and polymer to ultimately produce about 10/90, 20/80, 30/70, 40/60, 50/50, 60/40, 70/30, 80/20, 90/10 (or any ratio in between) dry mixture of the polymer and the salt by weight may be utilized.

Once the aqueous solution of salt has been combined with the polymer, the aqueous solution will be absorbed by the polymer. This creates a composition that includes dissociated salt, solid salt, polymer and polymer that has absorbed the aqueous salt solution. This composition can act as a desiccant. In embodiments, the water in the aqueous salt solution that has been absorbed by the polymer can be removed by drying the composition.

The second composition, once placed in a closed system that includes humid air (i.e., some amount of water vapor) will, over time, come to a three-way equilibrium with the partial pressure of water vapor in the air, the dissociated salt, and the salt present as a distinct, pure solid phase within the second composition. In this case, the concentration of dissolved salt and the partial pressure of water vapor are not arbitrary but locked to specific values based on the identity of the salt. This equilibrium state is stable, that is, the system will respond to perturbations by compensating changes in the opposing direction. Specifically, if the water vapor partial pressure in the closed system were increased by some artificial means, the solution would capture some water vapor from the air and dissolve more of the salt from the distinct, pure solid phase. In this way, the partial pressure of water in the air and the concentration of salt would be driven back towards their original levels. An artificial decrease in the water vapor partial pressure would bring about the reverse process with some salt precipitating out of the second composition and some liquid water evaporating from the second composition to increase the water vapor partial pressure within the system. In such a closed equilibrium system, the partial pressure of water vapor in the air is held to a specific value with little variation at substantially constant temperature.

Relative humidity (RH) is a direct function of the partial pressure of water vapor in the air. Therefore, the RH level of a closed equilibrium system comprised of humid air, an aqueous solution of a salt that includes distinct pure solid salt (i.e. a saturated solution) is fixed at a specific value. This RH value depends only on the temperature of the system and the identity of the salt used as described with respect to FIG. 1. (The dependence of equilibrium RH on total pressure is negligible). Table 1 shows some exemplary equilibrium humidity levels for saturated aqueous solutions of various salts at 25 degrees Celsius (° C.).

TABLE 1
Divalent cation salts show a wide range
of equilibrium (fixed point) RH levels

| | Equilibrium | |
|---|---|---|
| Salt | RH at 25° C. | Data Source |
| Zinc bromide (ZnBr₂ * 2H₂O) | 7.8% | 1 |
| Calcium bromide (CaBr₂ * 6H₂O) | 16.5% | 1 |
| Magnesium iodide (MgI₂ * 8H₂O) | 27.1% | 2 |
| Calcium chloride (CaCl₂ * 6H₂O) | 28.8% | 2 |
| Magnesium bromide (MgBr₂ * 6H₂O) | 31.8% | 2 |
| Magnesium chloride (MgCl₂ * 6H₂O) | 32.4% | 2 |
| Magnesium nitrate (Mg[NO₃]₂ * 6H₂O) | 52.0% | 3 |
| Cobalt chloride (CoCl₂ * 6H₂O) | 64.9% | 1 |
| Strontium chloride (SrCl₂ * 6H₂O) | 70.9% | 1 |
| Zinc sulfate (ZnSO₂ * 7H₂O) | 88.5% | 3 |
| Barium chloride (BaCl₂ * 2H₂O) | 90.2% | 2 |

1 Greenspan, Lewis, “Humidity Fixed Points of Binary Saturated Aqueous Solutions”, Journal of Research, NBS, vol. 81A, no. 1, pp. 89-96 (January-February 1977).
2 Richardson, G. M. & R. S. Malthus, “Salts for Static Control of Humidity at Relatively Low Levels”, Journal of Applied Chemistry, vol. 5, pp. 557-567 (1955).
3 O'Brien, F. E. M., “The Control of Humidity by Saturated Salt Solutions”, Journal of Scientific Instruments, vol. 25, pp. 73-76 (March 1948).

As seen from this table, the desired relative humidity to be maintained in a system can be varied based on the particular salt that is chosen.

The second composition also includes an absorbent polymer. The polymer functions to allow the second composition to function as if it were an aqueous solution without having to actually be an aqueous solution. Therefore, the absorbent polymer affords the second composition the ability to maintain a relative humidity within a system without actually having to be an aqueous solution, i.e. a liquid. The absorbent polymer absorbs the water of the aqueous solution, leaving dissolved salt and solid, pure salt within the mass of the absorbent polymer. Once the aqueous solution is absorbed by the absorbent polymer, it can function as a saturated aqueous solution (dissolving solid salt or crystallizing dissolved salt to maintain equilibrium with the water vapor above it). As the amount of water vapor in the enclosure is increased, the saturated aqueous solution will take the water in by dissolving some of the solid pure salt and the absorbent polymer will absorb the extra water that was taken from the atmosphere. As the amount of water vapor in the enclosure is decreased, the second composition can release water by evaporating some of the water absorbed by the polymer and some of the dissolved salt can be crystallized into solid pure salt. In this way, the absorbent polymer functions to maintain some properties of an aqueous solution in the second composition without the need to have any liquid water present.

Through the function of the aqueous solution, the second composition maintains a substantially constant relative humidity in the enclosure. In embodiments, substantially constant relative humidity means that the relative humidity within the enclosure does not vary by more than about 5%. In embodiments, substantially constant relative humidity means that the relative humidity within the enclosure does not vary by more than about 2%. In embodiments, substantially constant relative humidity means that the relative humidity within the enclosure does not vary by more than about 1%.

The specific amount of second composition per volume of enclosure can depend at least in part on the expected vapor pressure of water in the enclosure, the volume of the enclosure, the free volume in the enclosure and the type of article whose relative humidity is being controlled, or a combination thereof, for example. The amount of the second composition placed in the enclosure can depend at least in part on the volume of the enclosure. In embodiments, at least about 5 milligrams (mg) of the second composition per 1 mL of enclosure volume can be utilized.

Exemplary embodiments of methods can also include an optional step of drying the second composition before it is placed in the enclosure. The step of drying can be accomplished by heating the second composition to a temperature at which water will be evaporated from the second composition. In embodiments, the second composition can be heated to at least about 100° C. In embodiments, the second composition can be heated to at least about 110° C. In embodiments, the second composition can be heated to at least about 135° C. Once dried, the second composition can optionally be processed in order to form particulates of generally the same size. This can be advantageous in allowing water vapor to more easily reach the bulk of the second composition. Processing can be accomplished using mechanical processing methods such as various grinding processes for example.

The optional step of drying the second composition functions to remove substantially all of the water from the second composition leaving only dissolved salt, solid pure salt and absorbent polymer. In embodiments, substantially all of the water means that not more than 5% (by weight) of water remains in the second composition. In embodiments, substantially all of the water means that not more than 2% (by weight) of water remains in the second composition. In embodiments, substantially all of the water means that not more than 1% (by weight) of water remains in the second composition.

In embodiments where the second composition is dried before being placed in the enclosure, the dissolved salt and solid salt from the aqueous solution can function as if water were present even though substantially no water is present once the second composition is dried. It should be noted that once the second composition is exposed to an atmosphere containing water vapor, some water will be present within the second composition.

In embodiments where the second composition was dried before being placed in the enclosure, the second composition can include from about 10 wt % to about 80 wt % salt. As used in dry weight amounts, “salt” includes the associated salt (solid that is not dissolved) and the anion and cation from the salt (salt that was dissolved into solution). In embodiments where the second composition was dried before being placed in the enclosure, the second composition can include from about 30 wt % to about 70 wt % anhydrous salt. In embodiments where the second composition was dried before being placed in the enclosure, the second composition can include from about 40 wt % to about 60 wt % anhydrous salt. In embodiments where the second composition was dried before being placed in the enclosure, the second composition can include about 50 wt % anhydrous salt.

In embodiments where the second composition is dried before being placed in the enclosure, the solid salt from the aqueous solution, if a hydratable salt, has substantially all of the waters of hydration driven off by the drying process. In embodiments, substantially all of the waters of hydration means that not more than 5% (by weight) of the waters of hydration remain associated with the hydratable salt. In embodiments, substantially all of the waters of hydration means that not more than 2% (by weight) of the waters of hydration remain associated with the hydratable salt. In embodiments, substantially all of the waters of hydration means that not more than 1% (by weight) of the waters of hydration remain associated with the hydratable salt. As the second composition absorbs water vapor from the atmosphere within the enclosure, the water that is absorbed can rehydrate the hydratable salt that has been dehydrated by drying.

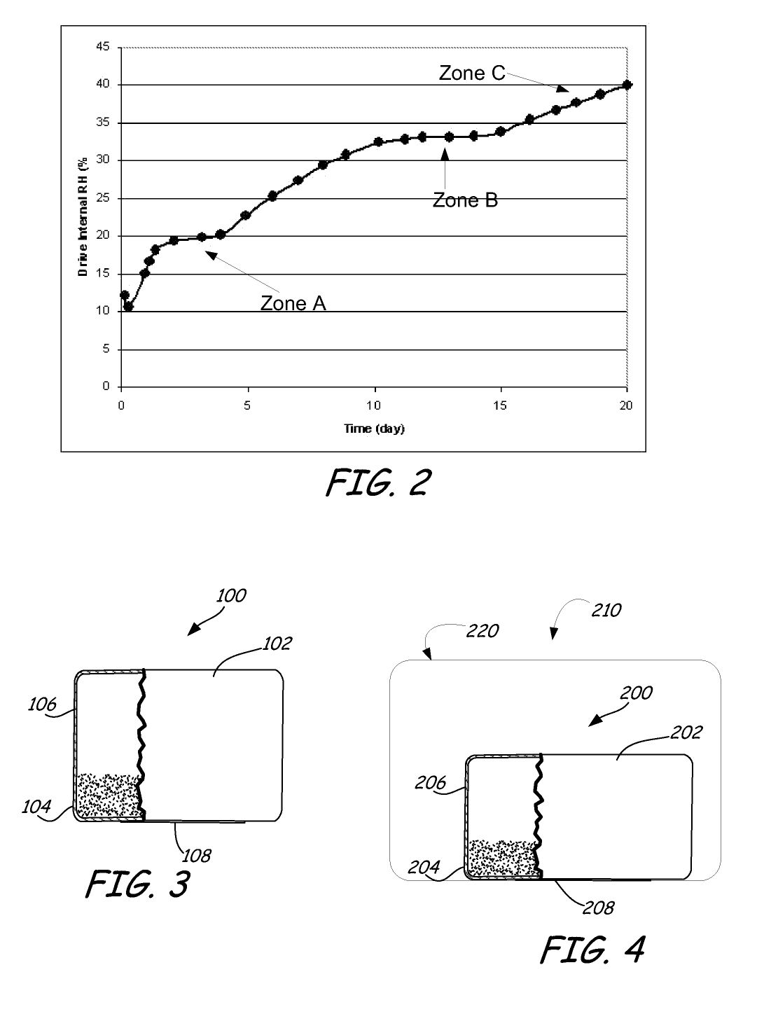

FIG. 2 demonstrates how the RH can change when a hydratable salt is utilized. The data shown in FIG. 2 was obtained by placing a dried (at about 120° C. for about 24 hours) composition containing 0.5 g of MgCl₂.6H₂O on Perfex polyurethane foam (Polyether 1.71 lb from Foamtec, International, Oceanside, Calif.) in a 0.8 inch (in)×0.3 in×0.3 in polycarbonate box. The box was sealed with a PTFE membrane. The box was then placed in a 3.5 inch desktop drive in a chamber held at 60° C. and 85% RH. The trace of RH in FIG. 2 shows three different zones. Zone A shows the RH change that is attributable to the hydration of the salt. Zone B shows the RH change that is attributable to the saturated solution absorbing water. Zone C shows that even when the solution is no longer saturated (too much water has been absorbed versus the amount of salt in the second composition), water is still absorbed by the second composition.

Also disclosed herein are desiccants. The second composition formed using methods as discussed above can be referred to as a desiccant. Desiccants can also be referred to as humidity control compositions. Disclosed desiccants can include an absorbent polymer, a first hydratable salt that includes a first cation and at least one of the first cation. Details regarding the absorbent polymer, the hydratable salt and the cation can be as discussed above. In embodiments, the desiccant includes polyacrylamide, a copolymer of polyacrylic acid and polyacrylamide or both; a hydratable slat that includes a divalent cation, and at least one divalent cation. The desiccant can include water before it is exposed to an atmosphere containing water vapor or can contain substantially no water before it is exposed to an atmosphere containing water vapor.

The desiccant can also include at least one anion. The at least one anion can be derived from the salt. As discussed above, as the aqueous solution was formed, at least a portion of the salt was dissolved, thereby breaking the ionic bond of the salt and causing it to exist as the cation and anion that formed the salt.

FIG. 3 is a partial cross-sectional view of another embodiment of a desiccant 100. In FIG. 3, the desiccant 100 includes a pouch 102 at least partially formed (in the exemplified embodiment of FIG. 3, substantially formed) of a vapor-permeable membrane 106 such as polytetrafluoroethylene (PTFE) for example. The second composition 104 is included within the pouch 102. As can be seen in FIG. 3, the desiccant 100 can also include a mounting element 108 for mounting desiccant 100 within an enclosure, such as a disc drive (not shown in FIG. 3). In some embodiments, mounting element 108 is an adhesive layer. Adhesive layer 108 may be a pressure sensitive adhesive or VELCRO® mounting or, in general, any type of hook and loop mounting mechanism may be utilized. In other embodiments, mechanical means for attaching the container (screws, clamps, clips, interference fits, wedges, etc.) may be employed as element 108.

A desiccant can also be utilized within a humidity control system. A humidity control system generally includes a desiccant and an enclosure. The desiccant functions to control the relative humidity within the enclosure. FIG. 4 is a partial cross-sectional view of an embodiment of a humidity control system 220. The humidity control system 220 includes an enclosure 210 with has within it a desiccant 200. The desiccant 200 can be as discussed above.

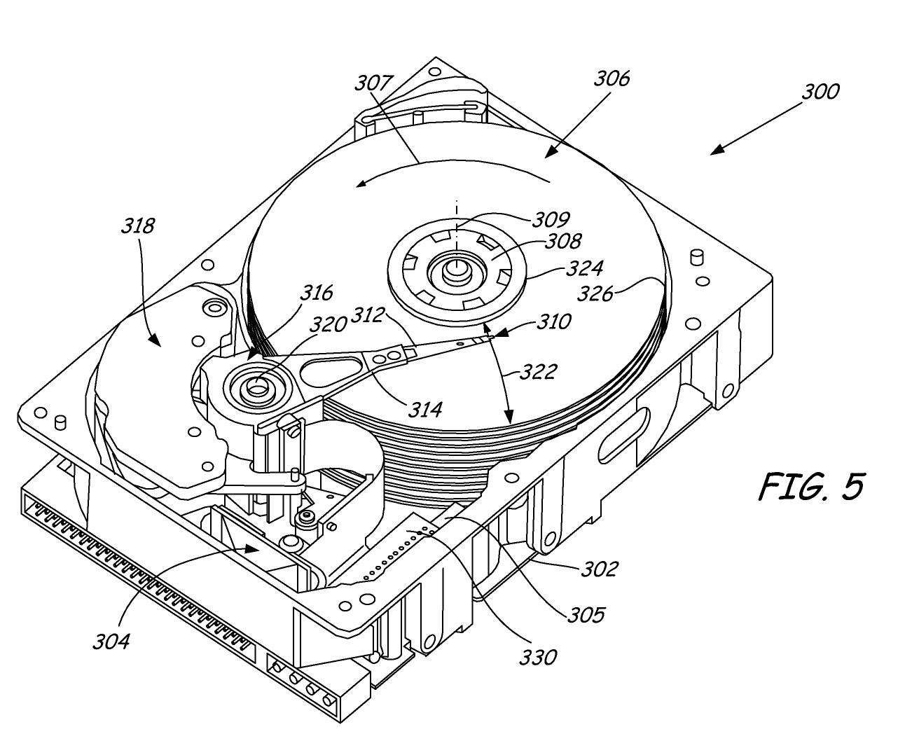

Exemplary enclosures that can house desiccants, i.e. exemplary enclosures that can be part of a humidity control system, include any enclosure that desirably has the relative humidity controlled within it. An exemplary embodiment of a humidity control system is discussed as being employed in a disc drive, the humidity control system can be employed in any enclosed system in which humidity control is desired. FIG. 5 illustrates an oblique view of a disc drive 300 in which desiccants can be advantageously utilized. Disc drive 300 includes a housing with a base 302 and a top cover (not shown) that closes the housing to form an enclosed assembly. The housing 302 may include a breathing hole (such as 304) that is sealed with a porous filter that allows air and humidity to move in and out of the disc drive 300 as temperature or atmospheric pressure changes. It should be noted that some embodiments of disc drives are hermetically sealed and therefore do not include a breathing hole. Disc drive 300 further includes a disc pack 306, which is mounted on a spindle motor (not shown) by a disc clamp 308. Disc pack 306 includes at least one disc, which is mounted for co-rotation in a direction indicated by arrow 307 about central axis 309. Each disc surface has an associated disc read/write head slider 310 which is mounted to disc drive 300 for communication with the disc surface. In the example shown in FIG. 5, sliders 310 are supported by suspensions 312 which are in turn attached to track accessing arms 314 of an actuator 316. The actuator shown in FIG. 5 is of the type known as a rotary moving coil actuator and includes a voice coil motor (VCM), shown generally at 318. Voice coil motor 318 rotates actuator 316 with its attached read/write heads 310 about a pivot shaft 320 to position read/write heads 310 over a desired data track along an arcuate path 322 between a disc inner diameter 324 and a disc outer diameter 326. Voice coil motor 318 is driven by electronics 330 based on signals generated by read/write heads 310 and a host computer (not shown). Disc drive 300 also includes a desiccant 305 as discussed above which maintains relatively constant humidity conditions inside drive 300.

In a disc drive application, a disclosed desiccant would counter changes in RH due to transport of water vapor into or out of the disc drive housing in order to maintain constant humidity conditions inside over the entire operating temperature range. It should be noted that both intentional and unintentional paths for ongoing ingress or egress of moisture are usually present in a disc drive. Diffusion through a port in the disc drive and permeation through seals, gaskets, etc., are examples of how moisture can reach the drive interior. Given a particular head/disc interface (HDI) design, an appropriate solute species that gives the desired RH level for that design can be selected.

FIGS. 6A and 6B are diagrammatic and cross-sectional views, respectively, of an embodiment of a desiccant where the container is only at least partially formed of a vapor permeable membrane. Here, humidity control device 400 is a box including a machined or molded portion 401 that is sealed with a permeable membrane or fabric 402, such as PTFE. Membrane 402 forms the top of the box and portion 401 forms side walls 404, and bottom 406, of the box. Portion 401 may be formed of plastic, for example. As can be seen in FIG. 6B, the interior of humidity control device 400 includes second composition 405 as discussed above. A mounting element (not shown in FIGS. 6A and 6B) may be attached to bottom 406 of humidity control device 400 for mounting in an enclosed assembly such as a disc drive.

Additional features might be incorporated into the above-described embodiments to enhance the overall functionality of the humidity control device. In some embodiments, side walls 404 may be formed of an elastic material to accommodate changes in volume within humidity control device 400 due to condensation of water vapor into and/or evaporation of water out of second composition 405 within humidity control device 400. Humidity control device 400, described above and shown in FIGS. 6A and 6B can include a single vapor-permeable membrane or patch 402 that forms the top of the container or box. A container such as this embodiment may be useful in applications where a concern regarding possible “creep” of the salt from the desiccant exists. It should be noted however that the described desiccants generally don't suffer from such problems because the polymer also serves to maintain the salt in the area of the desiccant, thereby limiting or even eliminating “creep” of the salt.

In embodiments that do utilize membranes such as those discussed above, there may be the potential for stratification of the solution by gravity. For some container orientations, condensation of water vapor may only occur near the liquid free surface, giving a reduced concentration of solute, and hence reduced capacity for RH control, there. This problem may be avoided by having vapor-permeable membrane patches located on various faces of the container that would allow water to be absorbed into the solution away from the free surface.

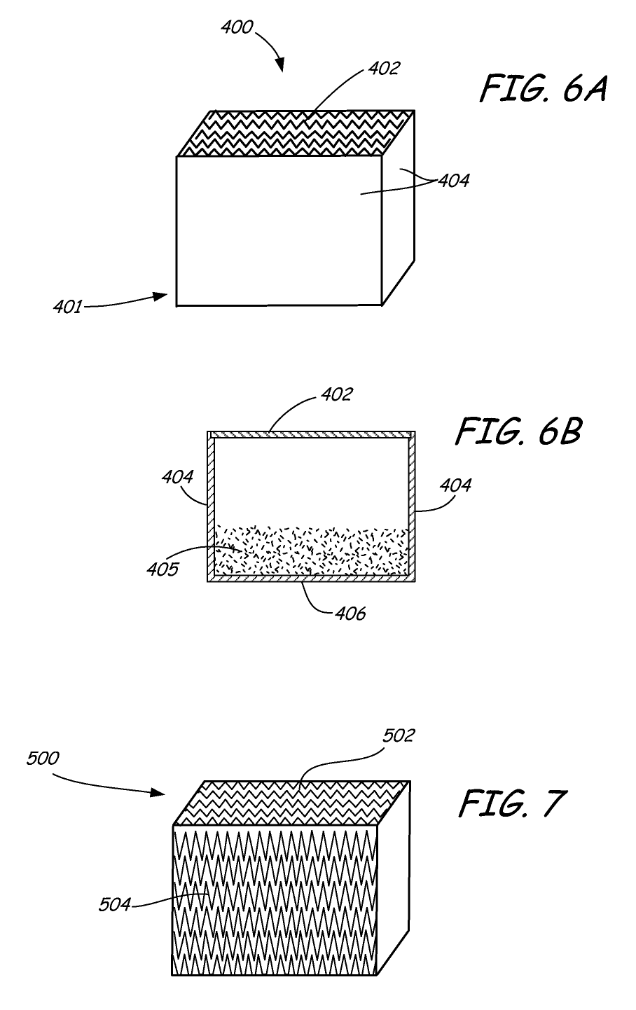

FIG. 7 shows a diagrammatic view of a humidity control device 500 that includes vapor-permeable membrane 502 and an additional vapor-permeable patch 504 on a side wall (such as 404 (FIG. 6A)). Convection currents driven by solution density gradients in the system of FIG. 7 would tend to de-stratify the solution; the system would be self-stirring. Such a system could be designed to work under any container orientation.

Embodiments of desiccants as disclosed herein can utilize divalent cations in hydratable salts. The use of hydratable salts that include divalent cations can be advantageous for a number of reasons. First, solutions of these hydratable salts can contain relatively large quantities of liquid water for a given weight of salt. Second, CaCl₂ and MgCl₂ (for example) have a RH at room temperature of about 33%, which is an advantageous RH for preventing both stiction and corrosion of heads and disks. Furthermore, they both have six waters of hydration, which is significantly more than other salts, thereby affording a greater capacity for water absorption.

In embodiments that utilize hydratable salts including divalent cations in combination with a copolymer of polyacrylic acid and polyacrylamide, highly effective desiccants can be obtained at concentrations by weight exceeding 50% anhydrous salt. In addition, the internal RH of water in a drive that includes a desiccant made from CaCl₂ and MgCl₂ and a copolymer of polyacrylic acid and polyacrylamide has two very static regions of RH. These static regions lie within the range of RH where a drive functions advantageously. It should be noted that other salts, such as those of strontium (Sr⁺²) and cobalt (Co⁺²) also exhibit such behavior, but at a RH that is less advantageous for disc drives. However, these RH ranges are likely useful for other applications.

In addition, such divalent salts have the advantageous property that their waters of hydration can be driven off at elevated temperatures (>100° C.). When the dried anhydrous salt is exposed to moist air, the water vapor will first be absorbed to replace the waters of hydration (Zone A of FIG. 2). Only when the waters of hydration are fully replaced does the external RH begin to rise. When the RH reaches the equilibrium RH of the saturated solution, the RH remains constant while the solid salt dissolves (Zone B of FIG. 2). When the solid salt is completely dissolved, then the RH above the solution will rise again. It is important to note that after all the salt is dissolved the RH will rise slowly as the concentration of the salt in the solution decreases (Zone C of FIG. 2). However, the RH will not approach 100% until the concentration of the salt approaches zero (infinite dilution). Thus the solution continues to act as a desiccant and will adsorb several times its weight.

Many salts, including hydratable salts having divalent cations have yet another valuable property, the equilibrium RH above their saturated solution decreases with increasing temperature. This can be advantageous because often, in warm conditions, the moisture level in the air increases so a lower RH at higher temperatures could serve to further counteract this phenomenon.

In some disk drive applications, it can be desirable to have a desiccant that has very high hysteresis. At the extreme, infinite hysteresis, or irreversible adsorption of water, could be quite useful. In some embodiments disclosed herein, the desiccants have irreversible adsorption of water plus hysteresis.

### EXAMPLES

### Example 1

40 mL of a 0.4 g/mL CaCl₂ (anhydrous weight) solution was added to 16.0 g of SOIL MOIST™ crosslinked polyacrylamide (JRM Chemical, Inc., Cleveland, Ohio) (ground and sieved to 25-50 mesh) with rapid stirring. After about 5 minutes of stirring the fluffy white solid was dried at 120°-130° C. overnight. It was then ground to a course powder in a mortar and pestle, which was immediately placed in a sealed glass jar for storage.

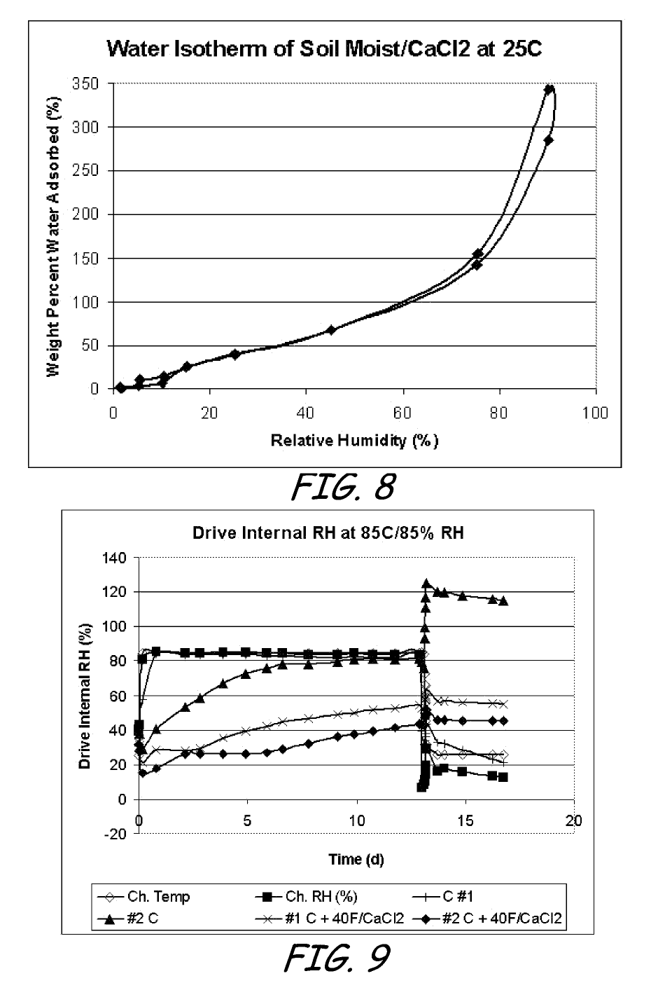

The water adsorption and desorption isotherm was run in the VTI SGA-100 isotherm instrument (VTI a TA Instruments Company, Hialeah, Fla.) to give the curve shown in FIG. 8. As seen in FIG. 8, the desiccant did not adsorb significant water until the RH exceeded about 18% and that at 90% RH it adsorbed over 340 wt % water.

### Example 2

40 mL of a 0.4 g/mL CaCl₂ solution (anhydrous weight) was added to 16g of LIQUIBLOCK™ 40F potassium salt of crosslinked polyacrylic acid/polyacrylamide copolymer (Emerging Technologies, Inc. Greensboro, N.C.) (ground and sieved to 25-50 mesh) with rapid stirring. After about 5 minutes of stirring the fluffy white solid was dried at about 135° C. overnight. It was then ground to a course powder in a mortar and pestle, which was immediately placed in a sealed glass jar for storage.

About 0.5 g of the powder prepared above was placed in a polycarbonate box (0.8 in×0.3 in×0.3 in) that was hand sealed with a PTFE membrane, then dried overnight at about 120° C. One box was placed in two identical 3.5 inch desktop disc drives (internal volume of about 110 mL) that also included about 0.11 g of activated carbon. For comparison, two identical 3.5 inch desktop disc drives containing only about 0.11 g of activated carbon was also monitored. The two drives were placed in a chamber being held at 85° C. and 85% RH.

The internal RH of the drives was measured using a Honeywell Model HIH 3602 humidity sensor (Honeywell Microswitch Division, 11 West Spring Street, Freport, Ill. 61032), which was mounted in each drive, over the course of 18 days. FIG. 9 shows the trace of the temperature in the chamber (Ch Temp), the relative humidity in the chamber (Ch RH(%)), the relative humidity in the drives with only the activated carbon (C #1 and C#2) and the relative humidity in the drives with the desiccant and carbon (#1 C+40F/CaCl2 and #2 C+40F/CaCl2).

As seen in FIG. 9, at about 12.5 hr, both the temperature and RH were reduced to about 25° C. and 15% RH respectively (poor chamber control at low RH). The drive with the desiccant as prepared above dropped to about 15% then rose and held at about 26% RH for several hours. Note that the equilibrium RH of CaCl₂ is about 33% at 20° C., proving that as the temperature rises, the RH decreases. It is also important to note that when the temperature and RH was reduced rapidly, the RH inside the drive that included the desiccant as prepared above hardly changed while the drive with activated carbon eventually rose to over 100% and condensation would have occurred within the drive.

### Example 3

About 0.5 g each of the desiccant prepared in Example 2 (CaCl₂ and LIQUIBLOCK™ 40F) was placed in were placed in boxes as described above in Example 2. The boxes were then placed in identical 3.5 inch desktop disc drives that also included about 0.11 g activated carbon. For comparison, two identical 3.5 inch desktop disc drives that included only the activated carbon were also monitored.

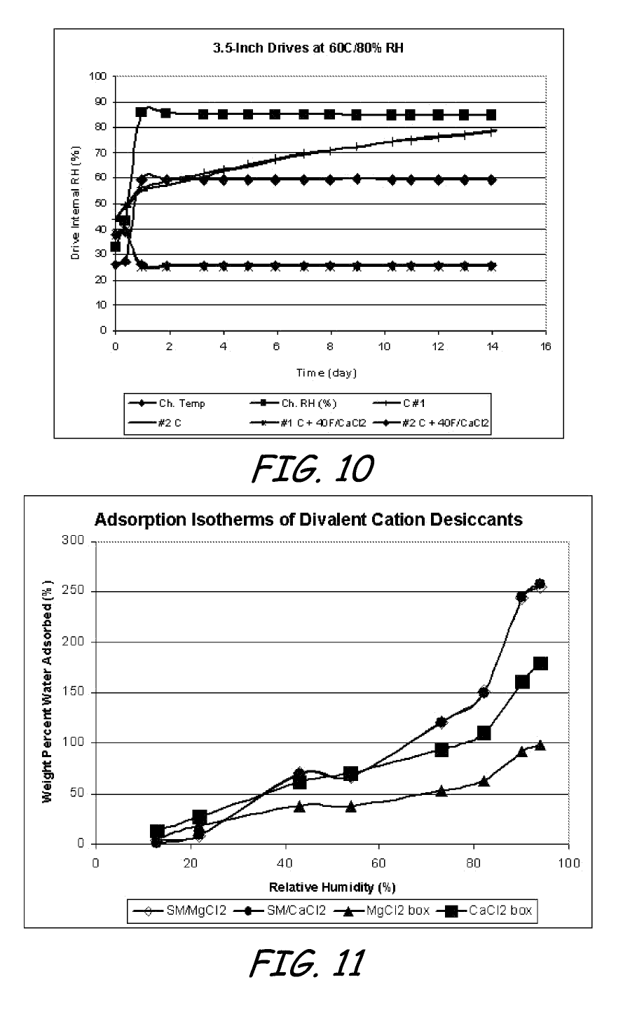

The four drives were placed in a chamber being held at 60° C. and 80% RH. The internal RH of the drives was measured using a Honeywell Model HIH 3602 humidity sensor (Honeywell Microswitch Division, 11 West Spring Street, Freport, Ill. 61032), which was mounted in each drive, over the course of 14 days. FIG. 10 shows the trace of the temperature in the chamber (Ch Temp), the relative humidity in the chamber (Ch RH(%)), the relative humidity in the drives with only the activated carbon (C #1 and #2 C) and the relative humidity in the drives with the desiccant of Example 2 and activated carbon (#1C+40F/CaCl2 and #2 C+40F/CaCl2). It should be noted that the two traces for the drives containing the desiccant of Example 2 exist on almost the same line and substantially constantly maintain the internal relative humidity of the drive at about 25% RH over the course of at least 14 days.

### Example 4

About 0.5 g of MgCl₂.6H₂O and 0.5 g of CaCl₂.6H₂O along with a drop of TRITON™ X-100 Surfactant (Dow Chemical Company, Midland, Mich.) was added to a sheet of Perfex polyurethane foam (Polyether 1.71 lb from Foamtec, International, Oceanside, Calif.) fit into 0.8 in×0.3 in×0.3 in polycarbonate boxes as described above. These samples were dried at about 120° C. for about 24 hours. In addition, solutions of 10 g of MgCl₂.6H₂O in 13 mL of water and a second sample of 10 g of CaCl₂.6H₂O were prepared. These solutions were added to 5 g of SOIL MOIST™ crosslinked polyacrylamide (JRM Chemical, Inc., Cleveland, Ohio) (ground and sieved to 25-50 mesh) with rapid stirring. After about 5 minutes of stirring the two fluffy white solids were dried separately at about 135° C. overnight. It was then ground to a course powder in a mortar and pestle, which was immediately placed in a sealed glass jar for storage. About 0.5 g of the powders prepared above were sealed in the boxes described in Example 2 above.

Saturated salt solutions that provided a controlled relative humidity environment were placed in a series of chambers made of anodized aluminum having about 1 cubic foot internal volume. The temperature of the chambers were maintained at room temperature (about 23° C.). The chambers contained LiCl (13% RH), KHCO₂ (formate, 22% RH), K₂CO₃ (43% RH), NaHSO₄ (54% RH), NaCl (73% RH), KCl (80% RH), KNO₃ (90% RH), and Na₂SO₄ (94% RH). The four samples discussed above were each weighed, dried, and weighed again to determine the dry weight of the sample and container (box or aluminum weighing pan). The samples were then placed in the first chamber, equilibrated over night and weighed to determine the weight of water that was adsorbed. The amount of water absorbed provided the first point on the graph. The samples were then placed in the next chamber, equilibrated and weighed until the data had been recorded for all eight relative humidity points.

FIG. 11 shows the results. The trace labeled “SM/MgCl2” is the desiccant that includes MgCl₂.6H₂O and SOIL MOIST™ crosslinked polyacrylamide; the trace labeled “SM/CaCl2” is the desiccant that includes CaCl₂.6H₂O and SOIL MOIST™ crosslinked polyacrylamide; the trace labeled “MgCl2 box” is the box containing MgCl₂.6H₂O and polyurethane; and the trace labeled “CaCl2 box” is the box containing CaCl₂.6H₂O and polyurethane.

Thus, embodiments of METHODS AND DEVICES FOR CONTROLLING RELATIVE HUMIDITY are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation, and the present disclosure is limited only by the claims that follow.

What is claimed is:

1. A method of controlling relative humidity in an enclosure, the method comprising:
preparing an aqueous solution, the aqueous solution comprising:
a hydratable salt, the hydratable salt comprising a divalent cation;
preparing a second composition, the second composition comprising:
the first composition; and
polyacrylamide, a copolymer of polyacrylic acid and polyacrylamide, or both; and
placing the second composition in the enclosure, wherein the second composition absorbs water from the atmosphere of the enclosure.

2. The method according to claim 1, wherein the second composition maintains a substantially constant relative humidity in the enclosure.

3. The method according to claim 1, wherein the hydratable salt is selected from the group consisting of: magnesium chloride, magnesium bromide, magnesium iodide, calcium chloride, calcium bromide, calcium iodide, strontium chloride, strontium bromide, strontium iodide, and combinations thereof.

4. The method according to claim 1, wherein the enclosure contains at least about 5 milligrams of the second composition per 1 milliliter of enclosure volume.

5. The method according to claim 1, wherein the second composition is dried before placing the second composition in the enclosure.

6. The method according to claim 1, wherein the relative humidity within the enclosure decreases as the temperature inside the enclosure increases.

7. The method according to claim 1, wherein all hydratable salt in the second composition has disassociated and the second composition is still absorbing water from the atmosphere of the enclosure.

8. A desiccant comprising:
polyacrylamide, a copolymer of polyacrylic acid and polyacrylamide, or both;
a hydratable salt, the hydratable salt comprising a divalent cation; and
at least one divalent cation.

9. The desiccant according to claim 8 further comprising water.

10. The desiccant according to claim 8, wherein the polyacrylamide is crosslinked.

11. The desiccant according to claim 8, wherein the hydratable salt is selected from the group consisting of: magnesium chloride, magnesium bromide, magnesium iodide, calcium chloride, calcium bromide, calcium iodide, strontium chloride, strontium bromide, strontium iodide, and combinations thereof.

12. The desiccant according to claim 8 further comprising at least one anion, wherein the at least one anion was derived from the hydratable salt.

13. The desiccant according to claim 12, wherein the desiccant comprises from about 10% to about 80% by weight of the hydratable salt, the divalent cation, and the at least one anion.

14. The desiccant according to claim 8, wherein the desiccant is enclosed in a container that is at least partially formed of a vapor-permeable membrane.

15. The humidity control system according to claim 14, wherein the vapor-permeable membrane comprises polytetrafluoroethylene.

16. A humidity control system comprising:
an enclosure;
a humidity control composition, the humidity control composition comprising:
polyacrylamide, a copolymer of polyacrylic acid and polyacrylamide, or both;
a hydratable salt, the hydratable salt comprising a divalent cation;
wherein the humidity control composition controls the relative humidity within the enclosure.

17. The humidity control system according to claim 16, wherein the humidity control composition is enclosed in a container that is at least partially formed of a vapor-permeable membrane.

18. The humidity control system according to claim 16, wherein the enclosure comprises a data storage device.

19. The humidity control system according to claim 16, wherein the hydratable salt is selected from the group consisting of: magnesium chloride, magnesium bromide, magnesium iodide, calcium chloride, calcium bromide, calcium iodide, strontium chloride, strontium bromide, strontium iodide, and combinations thereof.

20. The humidity control system according to claim 16, wherein the desiccant comprises from about 10% to about 80% by weight of the hydratable salt, the divalent cation, and the at least one anion.
